(19) United States
(12) Patent Application Publication
(10) Pub. No.: US 2021/0144942 A1
(43) Pub. Date: May 20, 2021

(54) PLANT GROWING STSTEM AND METHOD

(71) Applicant: CORSICA INNOVATIONS, INC., HOUSTON, TX (US)

(72) Inventors: JONATHAN OFIR, Irvine, CA (US); Eran Mordechay, Rishon Letsiyon (IL); Jenny Mreci, Pardesiya (IL); Bar Keshet, Jerusalem (IL)

(21) Appl. No.: 17/163,458

(22) Filed: Jan. 31, 2021

Related U.S. Application Data
(63) Continuation-in-part of application No. 15/739,944, filed on Dec. 26, 2017, now abandoned.
(60) Provisional application No. 62/183,303, filed on Jun. 23, 2015.

(51) Int. Cl. A01G 31/02; A01G 7/04

(52) U.S. Cl. CPC A01G 31/02; A01G 2031/006; A01G 7/045

(57) ABSTRACT

A plant growing device for personal home use in an insulated environment is disclosed as comprising a cabinet for accommodating different facilities of the plant growing device and a space for plant growth. The system further comprises at least one water tank having a water-based solution, at least one controller, a light source, a watering subsystem electrically connected to the controller, a plurality of environmental sensors for providing input data about environmental conditions, plant sensors electrically connected to said controller to provide input data about the plant physical parameters, water level sensors, a dosing subsystem controlled by the controller for selectively dispensing/delivering required amounts of nutrients into the water-based solution, a climate subsystem having an air cooler, air humidifier and air heater, a watering subsystem, and a communication module to communicate with a database server and a mobile device.

### CROSS-REFERENCE TO RELATED APPLICATIONS

This application is a CIP of U.S. patent application Ser. No. 15/739,944 which was filed on Dec. 26, 2017, which is a 371 of International Patent Application Number PCT/IL2016/050681 which was filed on Jun. 23, 2016, and which claims the priority benefit of United States Provisional Patent Application 62/183,303 which was filed on Jun. 23, 2015, the entire contents and disclosures of which are incorporated herein by reference and which claims priority therefrom.

### FIELD OF THE INVENTION

The present invention is in the field of plant growing and relates to a system and method providing an automatically controlled non-commercial plant growth environment. This particular invention is for home personal use plant growing device and applications.

### BACKGROUND OF THE INVENTION

Growing plants indoors has the advantages of faster growing due to potentially better control over the growing environment, such as light, water, humidity and fertilizers, used to cultivate the plant. Yet, maximizing the plants produce and health indoors is relatively expensive and complicated, especially to layman having no prior expertise, since usually a plant passes through several growth stages being different in their required environmental conditions. In addition, growing plants indoors may produce a strong odor which is undesired. Growing plants indoors may also cause water spillage, and often times, personal automatic plant growing endeavors end up with the death of the plants due to various human errors in the actions that yet require physical actions by the grower.

Various techniques have been developed for facilitating indoor methods for growing plants. For example, patent application US20170223912 discloses systems, apparatuses and methods for growing marijuana plants, particularly for regulated purposes, for example medical purposes or in some jurisdictions recreational purposes, have automated subsystems with sensors to provide feedback information about system, apparatus and plant growth parameters to one or more controllers so that the one or more controllers can alter one or more parameters to provide optimal conditions for the growing and harvesting of the marijuana plants. In particular aspects, the systems, apparatuses and methods provide control of odors produced during the growing of marijuana, root management of the marijuana plants and control over important levels of chemicals provided to the plants, for example enzymes and flavor additives.

US20140259920 discloses a high growth, high density, growing system and methods for example closed environment hydroponics system.

US20160212945 discloses a fodder growing system having a building slab and insulated walls and roof panels to form an insulated housing. A plurality of vertically spaced, thermally massive MgO composite platforms is supported at each end by uprights and stringers. An irrigation system includes control means for delivery of a selected, six-day irrigation program from a water supply to spray nozzles supported over each of said platforms. An illumination system controlled by the control means drives LED arrays (not shown) supported over each of said platforms. Temperature control means comprises a thermal collector heating hot water supply blended by a tempering valve with the cold-water supply under the control of the control means to control the temperature within the housing by controlling the temperature of the water supply.

US4368593 discloses a device used in hydroculture for the storage and dosed delivery of liquids, comprising a tank for containing a liquid, the tank having at least one opening for filling with the liquid and for discharge of the liquid from the tank, the tank being movably mounted in relation to a surrounding vessel so that the opening can be brought into a lower, operative, position, the liquid then passing from the tank into the surrounding vessel until the level of the liquid in said vessel reaches the level of said opening, the device then maintaining this liquid level.

Some of the cited prior art describe plant growing automatic systems however, there is a need for automatic plant growing systems that will be accessible for personal non-professional home users. In today's world, more and more private Cannabis individual users and non-cannabis related users want to have their freedom to personally grow plants or cannabis plants in their house for personal use instead of purchasing commercial products or produce. Some of the reasons that such users want to grow their plants by themselves are that the users can know and control the exact amounts of fertilizers and or substance(s) they consume. In addition, some users enjoy managing the process of growing plants by themselves and then use their plant products. However, most of these users lack professional understanding in the field of plant growing and Cannabis plant growing in particular and do not know how to optimally grow plants. Furthermore, some users don't have the time to occupy themselves with the plant growth. Furthermore, some users lack space in their disposal for using large plant growing systems as known in the art. Thus, there is an unmet need for an automatic plant growing system and method that will be easy to use and to maintain for non-professional home users in any climate.

Plants go through a series of stages as they grow and mature, and those different stages call for different amounts of light, nutrients, water and more. It's important to know these stages, to timely identify the ending of each stage, how long each stage last, know what each plant needs and when and to identify and solve various problems that may arise throughout a plant's growth process. Knowing where the plants are in their life cycle indicates, along with additional measured parameters, how to fertilize the plant, what environmental conditions should be provided and more.

One object of the present invention is to provide plant growth users an automatic plant growth system and method that will grow the plants without any need for the plant growth users to have any prior knowledge on how to grow plants and will prevent human errors.

Yet another object of the present invention is to provide users an automatic plant growth system and method having one or more user software applications that will notify the user about current plant growth and the current or upcoming required maintenance actions that are required from the user with instructions for continuing growth of the plants in an optimal manner in each plant growth stage.

One of the challenges in order to implement a home use automatic plant growth system and method is to maintain a desired steady climate and air composition inside a small plant growing cell inside a plant growing device configured by the system controller. Plant growing system and method in particular in a small, insulated plant growing space may have undesired fluctuations in the various climate parameters and the air composition such as but not limited to temperature, and desired air composition for example desired percentage of Co2 and humidity in the plant growing cell. Thus, another object of the present invention is to provide automatic plant growth system and method for home uses that significantly reduces the undesired fluctuations in the various climate parameters and maintains desired air composition in the plant growing compartments.

Yet another object of the present invention is to implement an easy to use home automatic plant growth system and method especially adapted for the non-professional plant growing users and to minimize human errors during the plant growth process.

Yet another object of the present invention is to provide an easy to use home automatic plant growth system and method especially adapted for the non-professional Cannabis plant growing home users by minimizing the intervention of the user with the plant growing system during the plant growth process.

Yet another object of the present invention is to provide an easy to use software application for the home automatic plant growth system and method which is especially adapted for the non-professional plant growing home users.

Yet another object of the present invention is to provide an easy to use software application for the home automatic plant growth system and method which enables sharing improved and innovative plant growing recipes and creating a crowd sourced database.

### SUMMARY OF THE INVENTION

The present invention is in the field of plant growing; and relates to a system and method providing an automatically controlled plant growth environment. The invention is particularly useful for indoors plant growing applications.

In accordance with an embodiment of the present invention there is provided a plant growing device for personal home use in an insulated environment including, a cabinet having a cabinet door and having a plurality of compartments for accommodating different facilities of the plant growing device and a space for plant growth. One or more water tanks having water-based solution inside said water tanks for said plant growth. The device further includes one or more controllers. A lighting means electrically connected to the controller the lighting means is used for lighting one or more of the compartments according to the controller instructions. The device further includes a watering subsystem electrically connected to said controller. One or more environmental sensors are used to provide input data about the environmental conditions in the plurality of compartments and in the room where the device is placed. Plant sensors electrically connected to the controller to provide input data about the plant physical parameters. Water level sensors where one or more of the sensors is electrically connecting to the controller to provide input data about the watering level in the one or more water tanks. A dosing subsystem controlled by the controller which is used for selectively dispensing/delivering the required amounts of each of a plurality of nutrients into the water-based solution inside the water tank automatically according to the instructions of the controller. A climate subsystem having an air cooler, air humidifier and air heater; the climate subsystem controlled by the controller. A watering subsystem controlled by the controller. Where, the plant growing device receives constant flow of renewed air from the atmosphere surrounding the cabinet though cabinet air inlet. The received flow of air flowing in a predefine path in various components of the climate subsystem controlled by the controller to change the air flow parameters and to prevent climate parameters volatility of predefined climate parameters in the cabinet in particular when air cooler is activated, for optimal growth of the plant; when the air reaches the end of said air path, the air flows outside of the plant growing device from a cabinet air outlet to the surrounding of cabinet atmosphere.

In accordance with an embodiment of the present invention there is provided a dedicated software application for measuring the produce and other parameters of the plant growth results, and for sharing growth protocol recipes between various users of the system and the manufacturer to increase collective knowledge and reach improved and innovative plant growing recipes. The results measurement can be performed by several methods, including but not limited to user evaluation, device sensors image processing of the leaves and flowers of the plant, before an/or after harvesting and by using external dedicated measurement devices for measurement of exact percentage of CBD and THC presence in Cannabis for example, thus utilizing crowd sourced collective database.

### BRIEF DESCRIPTION OF THE DRAWINGS

The invention may be understood upon reading of the following detailed description of non-limiting exemplary embodiments thereof, with reference to the following drawings, in which:

FIG. 1 is a perspective front view of a plant growing device in accordance with some embodiments of the present invention;

FIG. 2 is a schematic block diagram of the plant growing device in accordance with some embodiments of the present invention;

FIG. 3 is a perspective rear view of a plant growing device in accordance with some embodiments of the present invention;

FIG. 4 is a perspective sectional rear enlarged view of a plant growing device shown in FIG. 3;

FIG. 5 is a perspective rear view of the plant growing device describing the air flow path in an open system;

FIG. 6 is a schematic graph illustrating the CO2 concentration in the air in a closed system and in an open system as a function of time;

FIG. 7 is a schematic graph illustrating the plant growth chamber temperature relative to a desired temperature, in a closed system and in an open system as a function of time;

FIG. 8 is an upper view of the plant growing system in accordance with some embodiments of the present invention;

FIG. 9 is a side view of a heat exchanger in accordance with one embodiment of the present invention;

FIG. 10 is a side view showing components that are a part of the climate subsystem including components that are used to reduce the amount of excess water that are generated during the operation of the air conditioning in accordance with some embodiments of the present invention;

FIG. 11 is a perspective sectional front enlarged view of a plant growing device shown in FIG. 3;

FIG. 12 is a perspective front view of the plant growing device where the dosing subsystem is also shown;

FIG. 13 is a perspective side view of the dosing subsystem in accordance with some embodiments of the present invention attached to the plant water tank;

FIG. 14 is a perspective front view of the dosing subsystem in accordance with some embodiments of the present invention;

FIG. 15 is a perspective front view of the stirring unit assembly in accordance with some embodiments of the present invention;

FIG. 16 is a side view of the dosing sub-system in accordance with some embodiments of the present invention;

FIG. 17 is a perspective view of the stirring unit assembly in association with the stirring motor;

FIG. 18 is a perspective cut view of the cartridge in accordance with some embodiments of the present invention;

FIG. 19 is a perspective enlarge view describing an example of a means for preventing sediments of substances enter to the cartridge nozzle;

FIG. 20 is a perspective view of five cartridges in accordance with some embodiments of the present invention;

FIG. 21 is a perspective rear view of the dosing sub-system platform in accordance with some embodiments of the present invention;

FIG. 22 is a perspective side view of the plant growing device describing the humidifier sub-system;

FIG. 23 is a perspective side view of the humidifier sub-system in accordance with some embodiments of the present invention;

FIG. 24 is a flow chart describing a pre-grow mode of operation in accordance with some embodiments of the present invention;

FIG. 25 is a flow chart describing a grow recipe executer mode of operation in accordance with some embodiments of the present invention;

FIG. 26 is a flow chart describing a post grow mode of operation in accordance with some embodiments of the present invention;

FIG. 27 is a flow chart describing a drying mode of operation in accordance with some embodiments of the present invention;

FIG. 28 schematically describes a method for using a plant growing device of the present invention; and

FIG. 29 schematically describes another method for using a plant growing device of the present invention.

### DETAILED DESCRIPTION OF EMBODIMENTS OF THE INVENTION

The following detailed description of the invention refers to the accompanying drawings referred to above. Dimensions of components and features shown in the figures are chosen for convenience or clarity of presentation and are not necessarily shown to scale. Wherever possible, the same reference numbers will be used throughout the drawings and the following description to refer to the same and like parts.

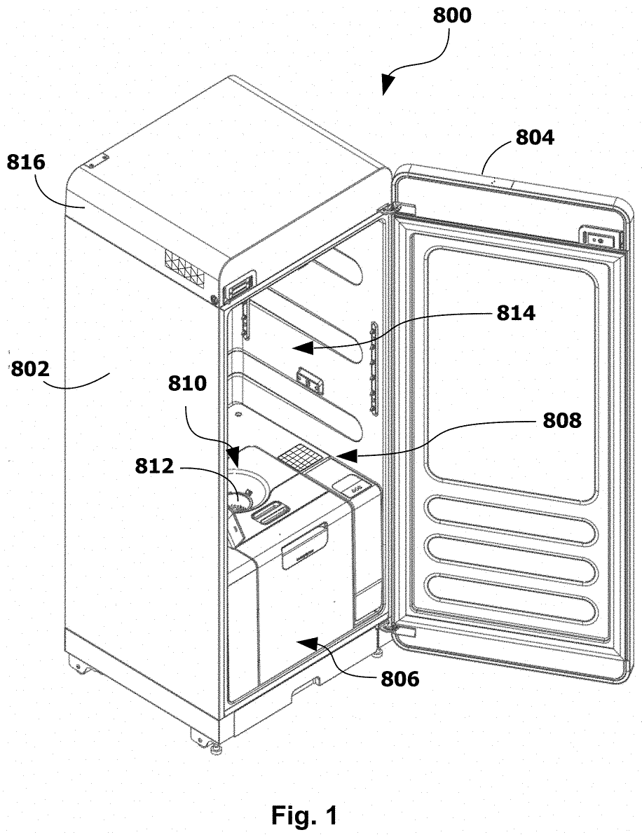

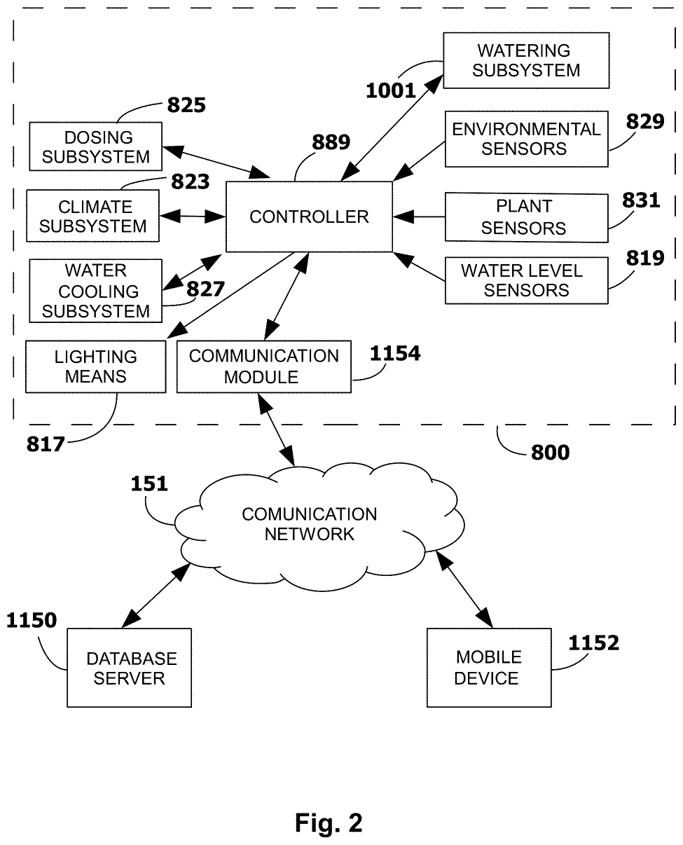

Referring first to FIGS. 1 and FIG. 2, a plant growing device 800 includes a cabinet 802 having a cabinet door 804. The cabinet 802 may typically have dimensions not exceeding 71, 71 and 165 cm, for its width, depth and height respectively, to enable its easy transportation into and outside of a building. One of the main uses of the device 800 is growing plants at home where the door entrances limit the mobility of big appliances. Inside the cabinet 802, there are three main compartments, from down up, a lower compartment 806 for accommodating different facilities such as a dosing subsystem 825 some parts of a climate subsystem 823 and a water cooling subsystem 827, a compartment 808 in the middle for accommodating a plant growing cell 810, e.g. a hydroponic growing cell is shown with a plant pot 812 placed on it in which the plant seeds or clone are placed, and an upper compartment 814 functioning as a plant-growing space and includes different sensors that monitor the environmental conditions 829 and the physical parameters of the plant 831. The input data collected from said sensors indicative of one or more environmental conditions may comprise one or more of the following conditions in a plant-growing space above the cell: illumination; temperature; humidity; air composition indicative of temperature and RH; odor. Also, the input data indicative of the environmental condition(s) may comprise at least one environmental condition inside the plant growing cell, such as temperature, RH, pH, TDS/EC, fluid level (the PH and TDS are the water conditions).

The sensors that monitor the physical parameters of the plant can be for example proximity sensor or alternatively infra red curtain to measure the plant height and camera sensor. The camera sensor can picture for example said plant during his plant growth to provide pictures and preferably video of the plant being grown which can be processed and analyzed by the controller 889 for optimal growing of the plant.

Some of the sensors monitors environmental conditions in the three compartments of the plant device and some of the environmental sensor can monitor the environmental conditions outside of the cabinet 804, in the room where the plant growing device 800 is placed.

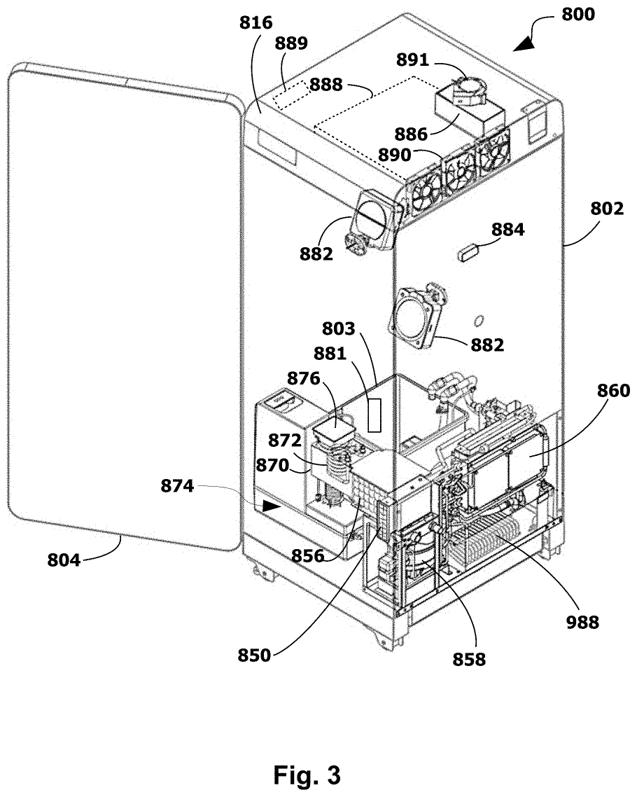

It should be understood that during plant growth, the device 800 is kept with its door 804 closed at all times, except for special occasions such as the need to take care of some of the operational systems inside. As such, the device 800 provides a totally insulated environment including from external light, temperature, so to make the plant-growing space 814 and growing cell 810 totally controlled by one or more controllers to control for example the climate and the light. Top cover housing 816 may include the electronic circuits of the device 800 and lighting means 888 such as but not limited to lamps and Light Emitting Diodes, LEDs for lighting for example the inner compartments 808 and 814 in the device 800. The lighting means 888 is shown schematically for example in FIG. 3. Preferably the growing device 800 utilizes a hydroponic growing method. For example, a water tank 803 is used to accommodate the plant's roots. One or more water level sensors 819 provides indication to a controller 889 when water should be added automatically to the water tank 803.

The plant growing device 800 includes the following subsystems, the climate subsystem 823, the dosing subsystem 825, the water-cooling subsystem 827 and door locking subsystem where one or more of the controllers 889 can control automatically one or more of the aforementioned subsystems.

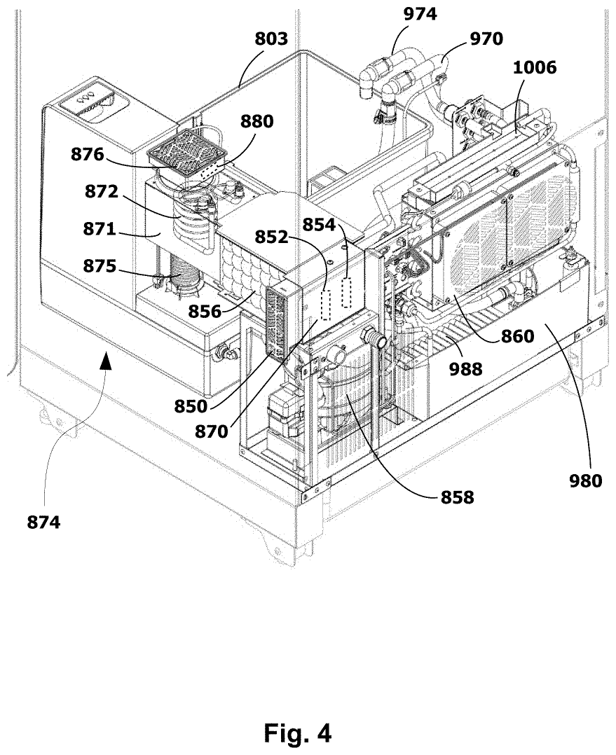

Referring to FIG. 3, FIG. 4 and FIG. 2, the climate subsystem 823 includes, a cabinet air inlet 850. Inside the cabinet air inlet 850 disposed one or more environmental sensors 829 such as but not limited to ambient temperature sensors 852 and one or more relative humidity (RH) sensors 854. The climate subsystem further includes an air conditioner (AC) having an evaporator 856, a compressor 858, a condenser 860. The climate subsystem further includes first air tunnel 870, a second air tunnel 871, a heater 872, a humidifier 874, a grow chamber air inlet fan 876, a water-cooling subsystem 827, a water temperature sensor 881 (shown schematically and located inside water tank 803), circulation fans 882, a grow chamber temp and RH sensor 884, lighting means cooling blower 891 and AC excess water reduction means. Cooling blower 891 main purpose is to take air out of the growing plant space 814 and create a low pressure that ensures the fresh air circulates through the climate system path. The AC excess water reduction means will be explained later with more detail.

In operation, the air conditioner (AC) is controlled by the controller 889. The air conditioner enables to cool and dry air in the cabinet plant-growing space 814. When required to cool and/or dry the air in the plant-growing space 814, the compressor 858 is turned on and the air cools and loses moisture while passing through the evaporator coils. When heating is required for heating the air in the plant growing space 814 the heater 872 operates and adjusts in different power levels and the air in plant growing space 814 is being heated while passing through the heater 872 or near the heater. For adding moisture to the plant growing space 814, when required, the humidifier 874 is instructed to operate by the controller 889 to generate water vapors which increase the moisture in the air in the plant growing space 814. The humidifier 874 can operate and be controlled by the controller 889 to use exact vibration frequencies (if using for example ultrasonic humidifier), thus generating water vapors in a precise rate and reaching optimal humidity level faster than humidifiers known in the art. The climate algorithm executed by the controller 889 is able to individually operate the compressor 858, the heater 872 and humidifier 874 enabling it to continuously reach the required temperature and relative humidity in the plant growing space 814.

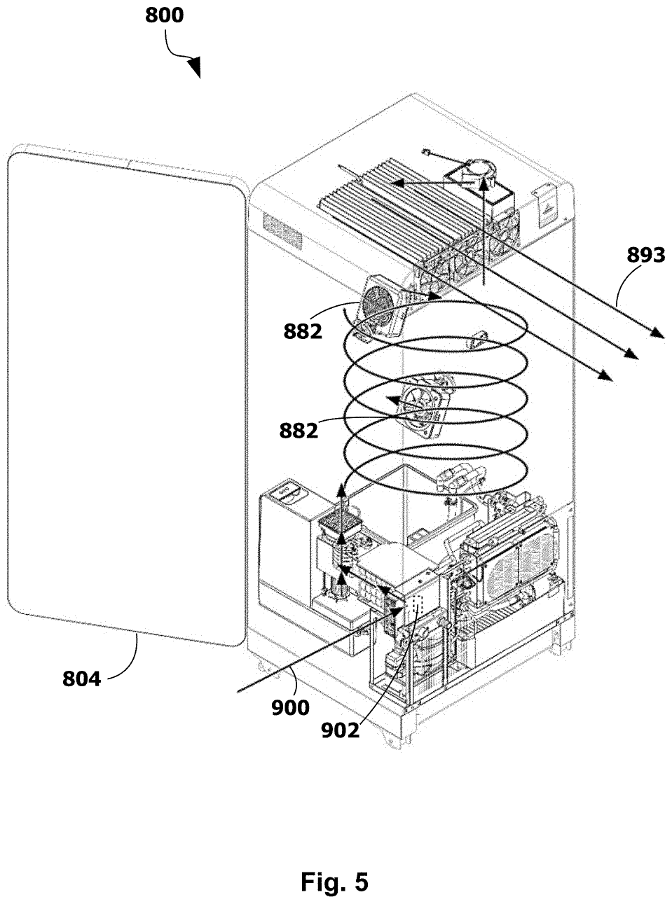

Referring to FIGS. 4 and 5 an open system in accordance with the present invention refers to as “renewable air” inside the plant growing device 800 by receiving a constant flow of air from the room atmosphere, flowing in a predefined path to various components in the plant growing device 800, air humidity and air temperature. When the air reaches the end of the path, the air flows outside of the plant growing device 800 back to the room atmosphere. One or more of the various components where the air flows can be automatically controlled at any time by the system controller 889 in order to optimize the plant growth in the plant growing device 800. The various components through which the air flows in the plant growing device are included as follows, the cabinet air inlet 850, first air tunnel 870, evaporator 856, second air tunnel 871, heater 872, humidifier 874, grow chamber air inlet fan 876, circulation fans 882, carbon filter 886, the blower 891, lighting means heat sink and air outlet fans 890. The heater can be for example a heating coil.

Referring also to FIGS. 4 and 5, air from the room designated by arrow 900 enters the cabinet air inlet 850 and filter 902, the air flows inside the first air tunnel 870 and passes through a fleece filter 902 (for preventing insects and dust penetration) to the evaporator 856 for cooling the air if needed and the heating coil 872 for heating the air if needed for optimal growth of the plant in the plant growth space 814. Water vapors generated by the humidifier 874 are added into the air through humidifier outlet of a vapor tube 875 for humidifying the air if needed for optimal growth of the plant in the plant growth space 814. The air is then pushed into the plant growth space 814 by the air inlet fan 876. The circulation fans 882 circulate the air inside the plant growth space 814 in order to create homogeneous conditions in the growing chamber 814 with the desired air temperature, CO₂ concentration and humidity for optimal growth of the plant in the plant growth space 814. The blower 891 pushes the air out of the growing chamber through a carbon filter 886 and towards the LED heatsink of lighting means 888 in order to cool and evacuate heat more efficiently. The carbon filter 886 ensures that odor from the plant growth space 814 does not reach the outside of the plant growing device 800. Finally, Air outlet fans 890 push the air back into the room, designated by parallel arrows 893.

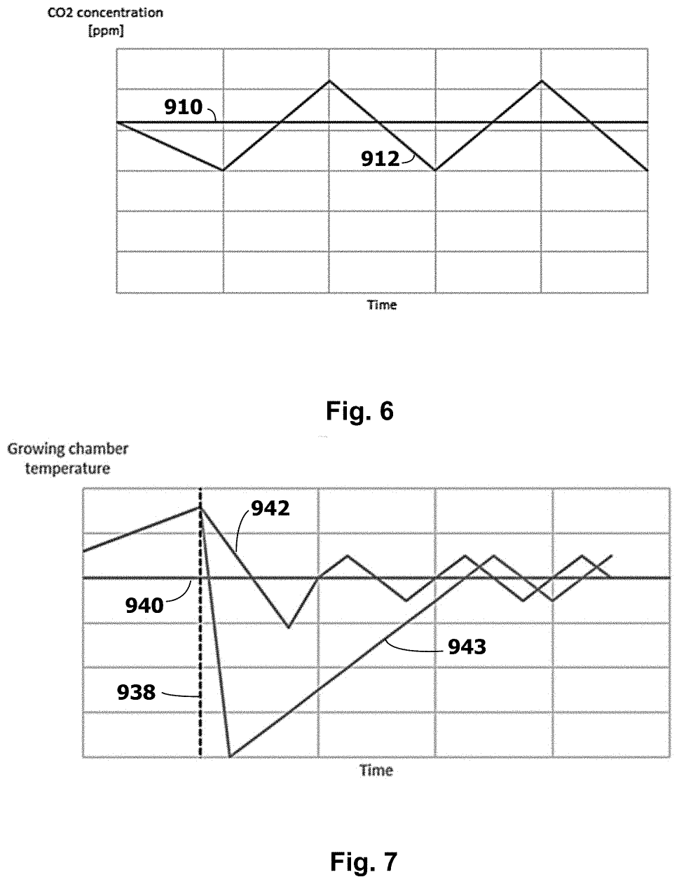

Referring to FIG. 6 and FIG. 7, as described above an open system as presented herein refers to a system that is insulated from outside climate conditions, but has a renewable air that comes from outside through a predetermined path and circulates inside plant growing device 800 while a closed system refers to a system with non-renewable air that circulates in the plant growing device 800. The system of the present invention is an open system plant growing device as described above. Bellow, are some of the benefits of an open system as described herein, compared to a closed system. Referring first to FIG. 6 this example illustrates one of the benefits of an open system compared to a closed system which is the ability to preserve a constant level of CO₂ in the plant growing space 814. During the plant growth process, a process of photosynthesis takes place during which the plant absorbs carbon dioxide (CO₂) and thus the CO₂ concentration in the plant growing space 814 decreases. The open system continuously introduces fresh air from the room atmosphere to the growing space 814 and thus causes the concentration of the carbon dioxide in the plant growing space 814 to remain constant and identical to that in the room atmosphere graph 910 illustrate schematically the constant CO₂ concentration in the plant growing space 814 as in function of time in an open system as presented herein, in accordance with some embodiments of the present invention. The desired constant CO₂ concentration in the plant growing space 814 ensures that the concentration level of CO₂ in the plant growing space 814 does not decrease and will allow the plant to carry out the process of photosynthesis.

This is in contrast to a closed system. In a closed system no renewable air enters the plant growing chambers and therefore there is a necessity to monitor the CO₂ levels in the plant growing chambers and to replenish the CO₂ according to the plant needs by adding CO₂ to the air composition in the plant growing chamber from a carbon dioxide reservoir. In such closed systems this disadvantage can be lethal to the plant due to poor puncturing of the carbon dioxide reservoir, need to replace the reservoir, error in monitoring accurate carbon levels in the plant growing chambers and more. Low CO₂ concentration in a plant growth chamber can be destructive to the plant, so using an open systems presented herein significantly reduces the risk of losing the plant or delaying the plant growth and ensures that the photosynthesis process which is necessary for plant growth will be carried out optimally. Graph 912 illustrates schematically the changes of the CO₂ concentration in a plant growing chamber 814 of a closed system plant growing device. The fluctuation CO₂ concentration in the plant growing space 814 may harm the plant growth and the plant photosynthesis process. This is especially important when using a small plant growth system such as the system presented here, a non-commercial automatic plant growth system for home use because of the ratio between the size of the plant and the plant growing chamber. In small spaces, CO₂ level can decrease rapidly in contrast to large spaces in which the CO₂ levels require more time to reach a critically low level.

Referring also to FIG. 7 in this example we illustrate another benefit of an open system compared to a closed system which is, the ability to control the temperature and the humidity in the plant growing space 814 more accurately and rapidly for maintaining a desired constant temperature and humidity values in the plant growing chamber 814. In order to overcome the undesired heating power generated by the lamp 888 in any system open or closed, it is necessary to turn on the compressor 858 the minimum cooling capacity of the compressor should be greater than the heat output produced by the lamp 888 in order to allow the plant growing space 814 to cool to the desired temperature for optimal growing of the plant when the lamp is lit. One of the disadvantages of a closed system is that in a closed system the compressor power is significantly greater than the power required to cool the plant growing space 814 when needed when the lamp 880 is turn off. Therefore, in a situation when the plant growing space 814 is required to be cooled down then an activation of the compressor 858 is made, resulting in a sharp temperature drop in the plant growing space 814. Moreover, when the compressor 858 is turned off, a sharp increase in the relative humidity in the plant growing space 814 up to the levels which could be dangerous to the plant without the possibility of lowering the humidity level.

However, in an open system that constantly draws “fresh” air and air is always renewed in the plant growing space 814, the drop in temperature when the compressor 858 is turned on is relatively slow and moderate (to the drop in closed systems) which facilitates higher control of conditions in the plant growing space 814. In addition, when the compressor 858 is turned off it is easier to maintain the relative humidity at the desired level. In conclusion, an open system as presented herein, for small home use plant growing device makes it possible to prevent the climate parameters volatility that occurs when the compressor 858 is switched on and off in a closed system. Referring to FIG. 7 there is shown a schematic illustration of the plant growing space 814 temperature as function of time. Three graphs are illustrated in FIG. 7 vertical line 938 designated the time where the compressor 858 is turned on. The first graph 940 designates the desired temperature in the plant growing space 814. The second graph 942 designates the temperature changes as function of time in an open system when the compressor 858 is turn on. The third graph 943 designates schematically the temperature changes as function of time in a closed system when the compressor 858 is turn on. As can be seen from the graphs the volatility of the temperature in open system is more moderate and accurate in respect to closed systems.

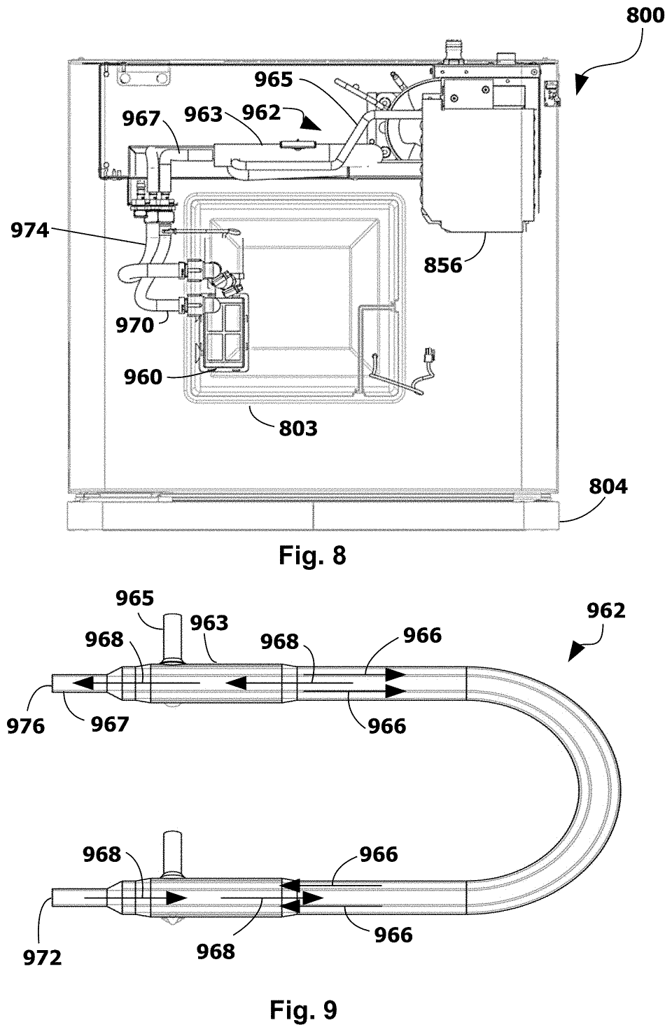

Referring to FIG. 8 and FIG. 9 in addition to the need of controlling the temperature and humidity of the air entering the plant growing space 814 as described above, the plant growing device 800 further includes the water cooling subsystem 827 which is used for cooling the water in the water tank 803 if needed preferably but not limited to a temperature as low as 17 degrees Celsius. The water-cooling subsystem 827 includes an immersed pump 960, a heat-exchanger 962 and two water tubes 970 and 974. when the temperature of the water in the plant water tank is above the desired temperature level, the immersed pump 960 flows water from the water tank 803 through the heat exchanger 962 and back to the water tank 803 in order to maintain the desired water temperature in the water tank 803. The heat exchanger 962 can be made of a copper tubes 963 which are connected by tube 965 to the evaporator 856 which is part of the climate subsystem 823. The copper tubes 963 have an inner stainless-steel water tube 967. The cold refrigerant gas that runs through tube 965 of the AC runs inside the copper tube 963 in the opposite direction to the water that flows from the immersed pump 960. A water tube 970 is connected in one end to the immersed pump 960 and the other end of water tube 970 is connected to an inlet 972 of the heat exchanger 962. A second water tube 974 is connected in one end to an outlet 976 of the heat exchanger 962. the other end of the water tube 974 is connected to the water tank 803 and is used for returning the water back to the water tank 803 after the water being cooled by the heat exchanger 962. The flow of the water that flows from the immersed pump is designated by arrows 968. The cold refrigerant gas of the AC that runs around the water tube in the direction opposite to the water that flows from the immersed pump 960 is designated by arrows 966. One of the benefits of the heat exchanger 962 is that the heat exchanger supports faster heat transfer which can be referred to as “counterflow heat exchanger” which cools the water in the inner tube 967. Lowering the water temperature in the water tank 803 to the required temperature for example around 19 degrees Celsius might be critical for optimal plant growth in the water tank 803 and can prevent root rot which may seriously damage the plant.

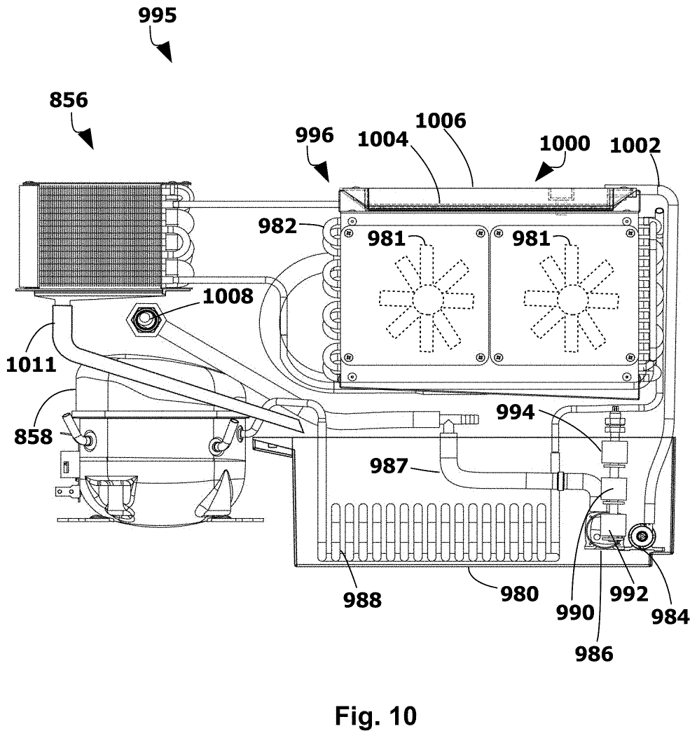

Referring to FIG. 10 and FIG. 2, when the air conditioner 995 is activated for cooling the plant growth compartment 814, like in any typical air conditioning (AC) during the flow of air in the evaporator 996 a process of condensation takes place that creates undesired drops of water. In accordance with some embodiments of the present invention there is provided means for collecting the drops of water and accelerating the process of water evaporation of excess water which will be referred to as excess water reduction subsystem. In an open system as presented herein, the continuous entrance of fresh air from outside and the conditioning thereof, causes excess water generation and said excess water need to be disposed of. As a standalone indoor home appliance, it is imperative to offer an independent solution for the excess water other than streaming the water outside the house (as in a regular home air conditioning system).

In FIG. 10 there is shown a water storage tank 980 for collecting the drops of water that drops from the evaporator 856 to the storage tank 980 through hose 1011. There is shown also, condenser fans 981, two immersed pumps 984, 986, water heating element 988, water level sensors 990,992,994 (such as but not limited to float level sensors), the condenser 982 of the air conditioner 995, compressor 858 of the air conditioner 995, and a means 1000 for dropping drops of water on the condenser coils 982 which will be explained later in more detail. The storage tank 980 is a reservoir that collects the drops of water that drops from the evaporator 856. The coiled heating element 988 is positioned inside the water tank 980 in order to evaporate the water stored in the water tank and thus help the plant growing system to dispose of said excess water. The water level sensor 994 measures the water level inside the water tank 980.

If the water level inside the water tank 980 exceed a predetermined level, an immersed pump 984 is activated to transfer water from the water tank 980 through the tube 1002 to the means 1000 for dropping drops of water on the condenser coils 982 which can be but not limited to a tray with holes for dropping drops of water on the hot condenser coils 982, to be evaporated and evacuated out of the plant growing device 800 by the adjacent condenser fans 981.

If the water level inside the water tank 980 exceed a maximum predetermined level, an immersed pump 986 is activated for passing water outside of the plant growing device 800 by a tube or hose 987 to an external tank/to the city/ municipality sewage system and through the outlet 1008.

The water dripping means 1000 can be constructed from a perforated floor 1004 having rigid panels extended upwards from the floor edges and surrounding the perforated floor to create a cavity. The drops of water that drops from the water dripping means 1000 drop on the relatively hot condenser coils 982 which causes the drops of water to evaporate, the fans 981 of the condenser 996 help accelerate the evaporation of the excess water. These aforementioned methods for disposing undesired excess of water in the plant growing device 800 significantly reduce the amount of water that accumulates in water tank 980. It is important to reduce as much as possible the water level in the excess water tank 980 in particular in-home plant growth devices 800 where emptying the water tank 980 can require a physical action from the user.

Referring to FIG. 11, FIG. 10 and FIG. 2, in accordance with some embodiments of the present invention there is provided a watering subsystem 1001 for filling the water tank 803 or emptying the water tank 803 and the water tank 980. Two methods can be used for filling and/or emptying the water in the water tank 803 and emptying water tank 980. The first method is to connect the plant growing device 800 to the city water supply through a city inlet valve connected to a tube or a hose 1018. The second method is filing the water tank 803 manually, not shown, this is done by the user and does not involve any pump. If this option is selected by the user, the device 800 will notify the user when a water filling is required and will instruct the user on the necessary amount of water that needs to be added to the water tank 803. Hose 1016 is connected to water pump 1012 from one side and to water outlet 1021 from the other side. Emptying the water from the water tank 803 is done by using pump 1012 and thus be emptied automatically to the city water drain if the device 800 is constantly connected to the city water drain. If the device 800 is not constantly connected to the city water drain, the device 800 will notify the user whenever it is required to connect the machine's outlet to a water drain for example a sink.

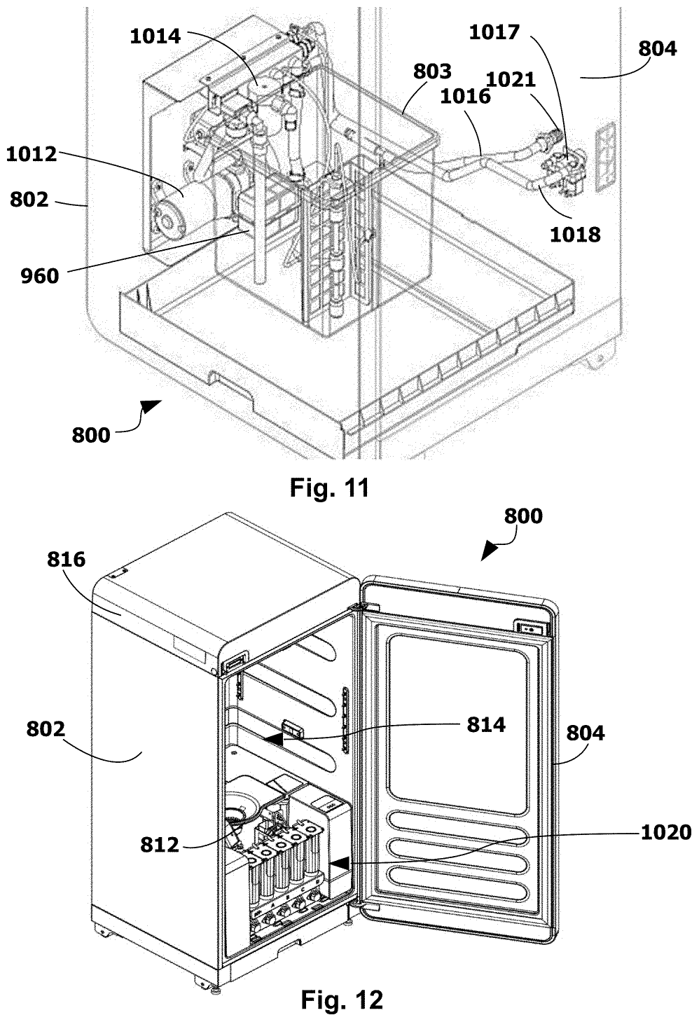

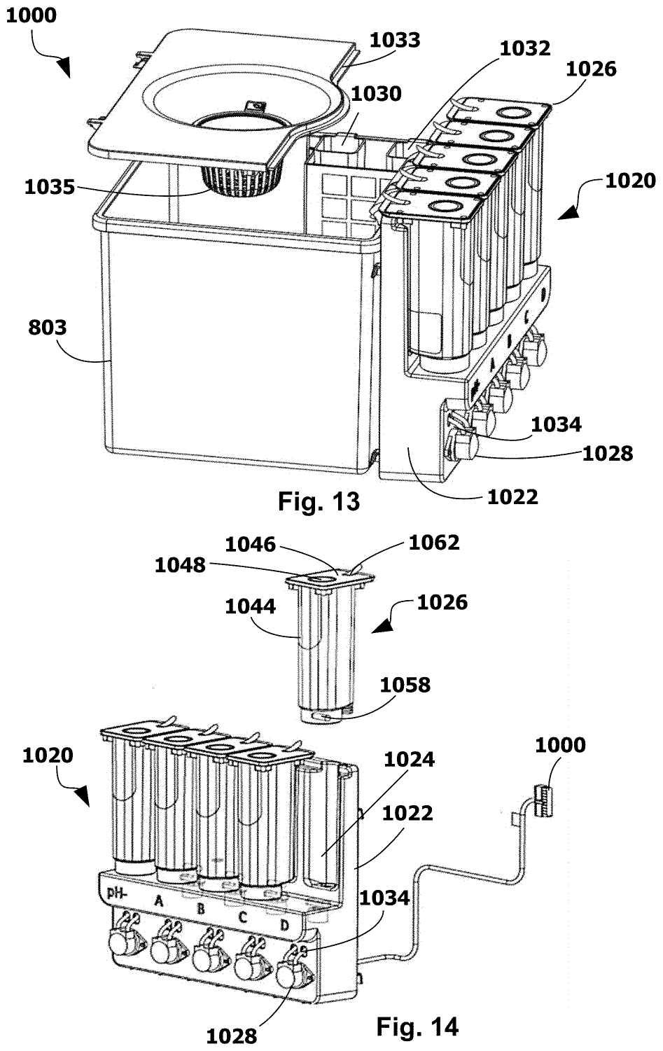

Referring to FIGS. 12, 13 and 14 there is provided a dosing subsystem 1020 in accordance with some embodiments of the present invention which is responsible for selectively dispensing/delivering the required amounts of each of a plurality of nutrients into the water-based solution inside the water tank 803 automatically according to the controller instructions. Reference is made to FIG. 13 showing the dosing system 1020. As shown, the dosing system 1020 includes a platform 1022 having five non-limiting example of detachable and replaceable cartridges 1026 arranged in a spaced-apart relationship, and each being configured to be connected to a respective dosing pump 1028 each pump 1028 having respective pump tubes 1034. It should be noted, that each cartridge 1026 carries a specific nutrient or mixture of nutrients, and one or more may also carry a pH stabilizer, such that the dosing system is capable of delivering one or more nutrients simultaneously or sequentially in exact timing and dosage as will be automatically instructed by the controller to the water-based solution inside the water tank 803. The dosing system 1020 further includes pH sensor 1030 connected to the controller to monitor the hydrogen-ion activity in water-based solutions inside the water tank 803, indicating its acidity or alkalinity expressed as pH. The dosing system 1020 includes also an electrical conductivity (EC) sensor 1032 connected to the controller to monitor and measure the electrical conductivity in the water-based solution in the water tank 803. On the water tank 803 attached a pot-shelf 1033 and a mesh-pot 1035 on which the plant is growing. The mesh pot is immersed in the water-based solutions inside the water tank 803.

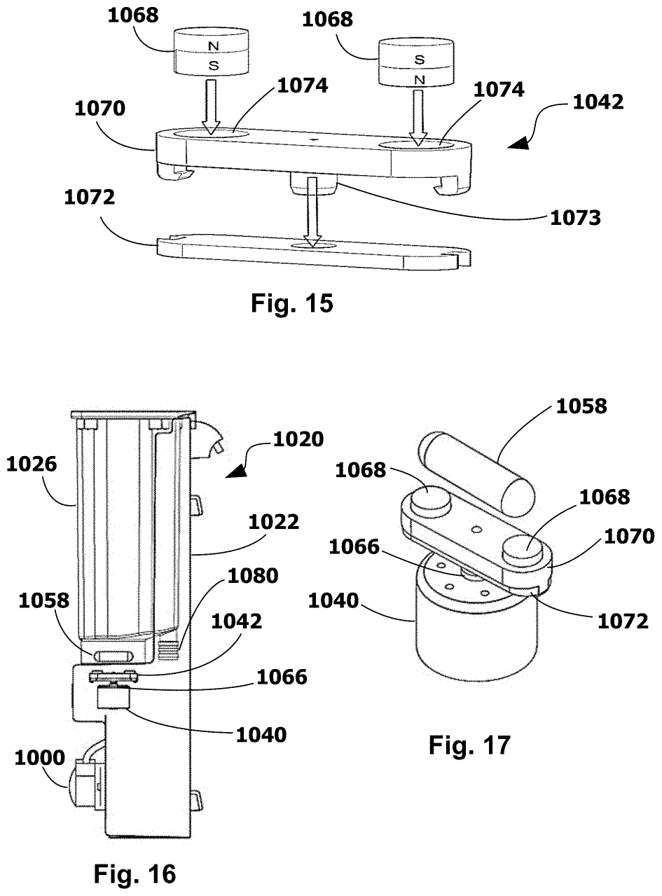

Referring also to FIGS. 15,16 and 17, the dosing system 1020 further includes stirring motors 1040 for each cartridge and a stirring unit assembly 1042. The purpose of the stirring motors 1040 and the stirring unit assembly 1042 will be explained later in more detail. The dosing cartridge 1026 includes a container 1044, a cover 1046, a cap 1048, check valve with nozzle 1080, stirring element means 1058, mechanical coding means 1104 and an air release hole 1062. In order to prevent sediments of the fertilizers contained in the cartridges 1026, each cartridge 1026 has a stirring element means which can be in one embodiment of the present invention a magnetic stirring element. During the filling process of the fertilizers inside the cartridges 1026, which is made during the production of the cartridges 1026 in the cartridge's factory the magnetic stirring element 1058 is also inserted inside of the cartridge 1026. The bottom portion of the stirring unit assembly is connected to a motor shaft 1066 of the stirring motors 1040 which are controlled by the controller. The stirring unit assembly includes in this example and without limitation two stirring magnets 1068 a rotating magnets arm 1070 and rotating arm support 1072. The rotating magnets arm 1070 have holes 1074 fitted such that the stirring magnets 1068 can inserted by pressure in the holes 1074. The rotating magnets arm 1070 is attached to the arm support 1072. The stirring unit assembly 1042 further includes a motor shaft attachment means 1073 which can be any suitable shaft attachment to attach the rotating magnets arm 1070 to the stirring motors shafts 1066. When one or more of the stirring motors 1040 is instructed by the controller to operate the stirring motor 1040, the stirring motor shafts are rotated 1066 and thus the respective magnet arm 1070 is rotated around the stirring motor shaft 1066. Stirring magnets 1068 are then also rotated which causes the magnet stirring element 1058 inside the cartridge 1026 to spin. The spin of the stirring element 1058 inside the cartridge 1026 mixes the fertilizers in the cartridge 1026 and thus preventing sediments of the fertilizers in the bottom surface of the cartridge 1026. This process of mixing the fertilizers in the cartridge 1026 is controlled automatically by the controller 889 and can be operated for example a number of times per day and thus the user doesn't need mix the cartridges 1026 by himself and doesn't need to do any action regarding to the implementation of this process. The stirring action is possible due to the fact that the polarity of the two magnets is reversed which allows the stirring element inside each cartridge 1026 to spin while keeping its orientation.

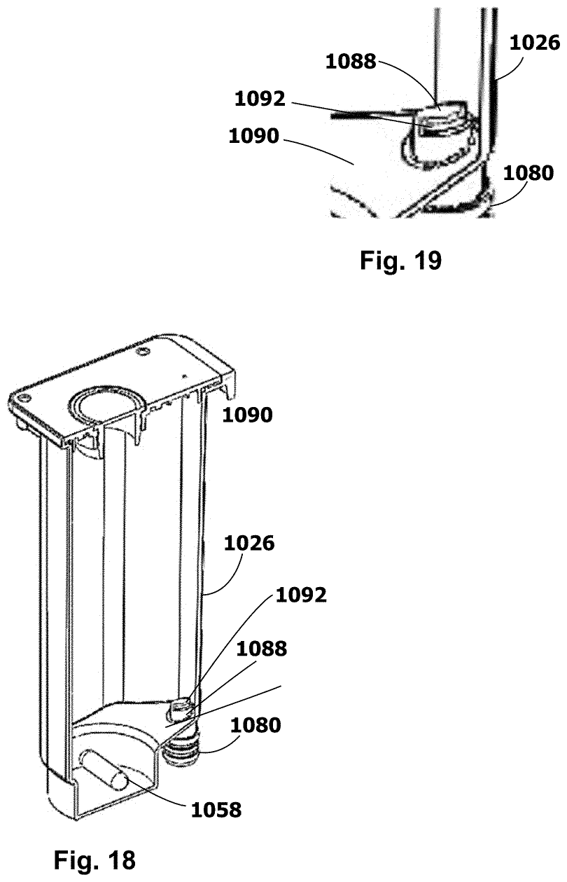

Referring also to FIGS. 18 and 19 cartridge 1026 further includes a nozzle 1080 for dispensing the fertilizers content that are inside the cartridges 1026 to the water tank 803 through tubs 1034 of pumps 1028. The dosing system 1020 may also include valves, not shown, which can be controllable that allows one direction flow of the fertilizers from the cartridge 1026 to the water-based solution water tank 803 when the respective pump 1028 is operated. In accordance with some embodiments of the present invention the cartridge 1026 further includes an element 1088 or a sediments filter for preventing the nozzle 1080 from being clogged by fertilizer's sediments. Element 1088 can be for example a protruded hollow element attached perpendicular to the nozzle 1080 having a notch 1092 from which the fertilizer content inside the cartridge 1026 can pass through to the nozzle 1080. the element 1088 extends upwards from cartridge base 1090 and is not pointing to the stirring direction thus, prevents the sediments if exist in the cartridge 1026 from clogging the element notch 1092.

One of the benefits of the replaceable cartridges 1026 is that the user doesn't need to have a knowledge in fertilizing plants he simply can receive a notification for example by an application installed in his Smartphone that notifies him when to replace a certain cartridge 1026. The user can order new and a specific nutrient cartridge 1026 with the specific fertilizing substance in the internet and also doesn't need to manually mix the fertilizers inside the cartridge and thus prevents common human errors.

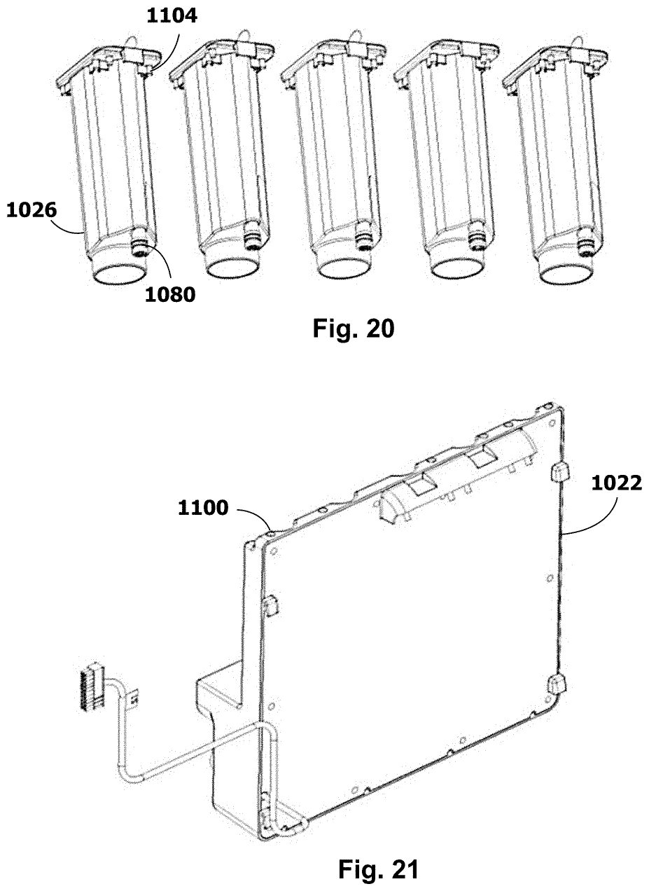

Referring now to FIGS. 20 and 21 in accordance with some embodiment of the present invention there is provided a mechanical code means for ensuring that every cartridge is placed in the right order and place in the platform 1022. This placement order is important to ensure that the user will not attach the replacement cartridge 1026 in a wrong place by mistake, thus for example, may releasing wrong fertilizer content from one or more of the cartridges 1026 by the system controller dosing system. The mechanical coding means may include one or more holes 1100 placed on the upper portion of the platform and one or more protruded elements 1104 extending downwards from the upper portion of the cartridge 1026. Each hole in the platform fit to the responding protruded element in the cartridge only if the right cartridge is inserted in the correct place in the platform 1022.

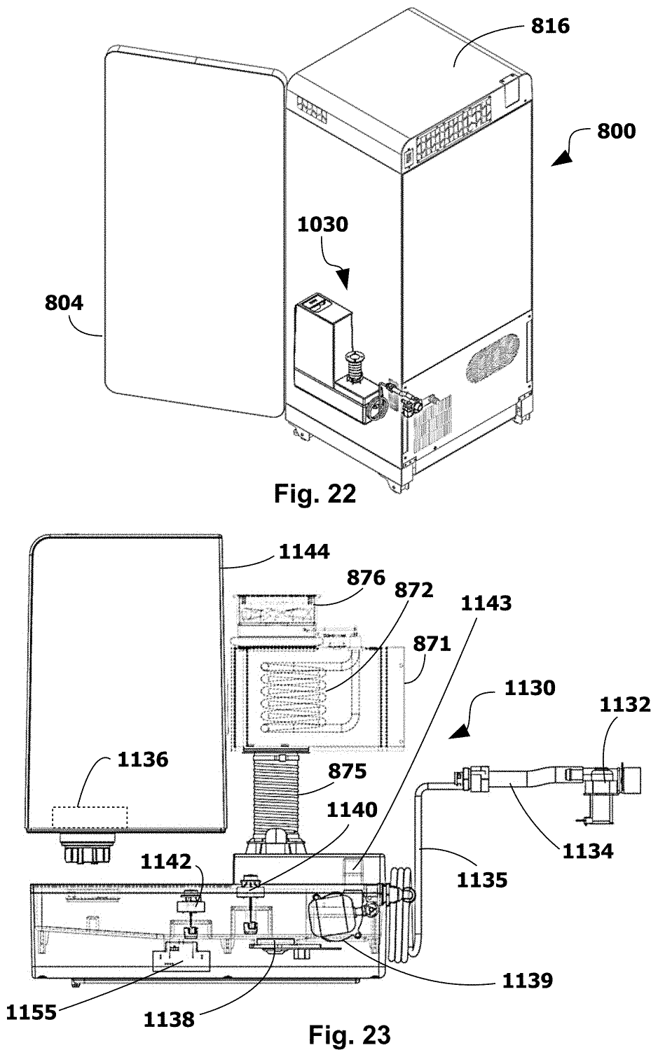

Referring now to FIGS. 22, 23 and 2 the climate subsystem 825 includes humidifier 1130 which includes, city inlet valve 1132, water tubes 1134, 1135, float valve 1139, piezoelectric transducer 1138, float sensor one 1140, float sensor two 1142, humidifier fan 1143, humidifier water tank 1144, humidifier water tank valve 1136, connection circuit board 1155 and the vapor tube 875. When the humidifier 1130 is activated the heater 872 can also be activated, the heater 872 is positioned in the same tunnel 871 where the humidifier output outputs the water vapors. The fresh or conditioned air come from evaporator 856 and flows also to tunnel 871. The activation of the heater 872 allows the air to absorb a higher amount of water vapor in warm air than in cold air and thus can be used to relatively rapidly increase the humidity in the fresh or conditioned air that will be flown to the plant growing space 814.

In order for the humidifier 1130 to work properly, the bottom part of the humidifier 1130 which includes the piezoelectric transducer 1138 must be filled with water, this may be achieved in two ways. The humidifier 1130 can be connected to an external water supply using an electrical valve 1132. The humidifier has two float sensors 1142 and 1140 that monitor the water level at all time and make sure there is sufficient water in order for the humidifier to be [symbol] device 800 correctly in his house. Afterward the user is guided how to assemble the device 800, then activating the device 800 connecting through wired or wireless communication network 151 for example but not limited to WIFI protocol for communicating with a dedicated application for example on the user's Smart phone, personal computer or any other suitable mobile device 1152 to communicate to the server 1150 of the provider or manufacturer of device 800. After the previous step the user can define the water supply mode which can be city waterline standalone water line or hybrid water supply mode. After the previous step the user get seed or clone to start growing the plant.

In standby mode the plant growing device 800 is turned on and waits for input from the user.

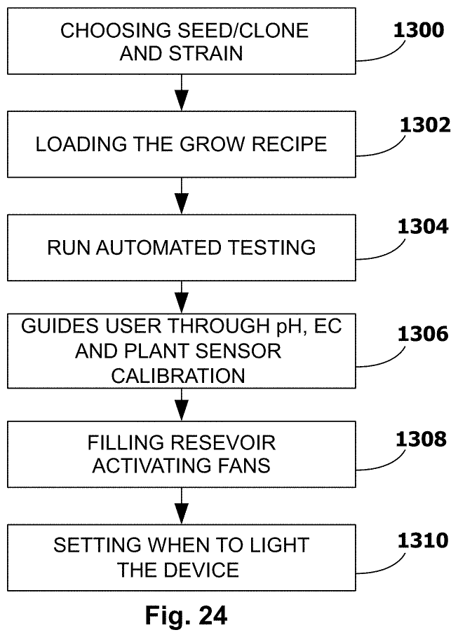

Referring to FIG. 24 in pre-grow mode the user chooses seed/clone and strain in step 1300. In step 1302, the device 800 load the grow recipe data from the server 1150 and database to the plant growing device through a communication module 1154 electrically connected to the plant growing device 800. The communication module 1154 may include any wired or wireless communications using communication protocols such as but not limited to BlueTooth, WIFI, LAN and t4he like. The communication module is electrically connected to the device controller 889 and the received data can be stored in a memory which is electrically connected to the controller of the device 800. In step 1304, the controller 889 runs automated testing to check if all the electrical and electromechanical components of the device are working. In step 1306, the device 800 send notification to the user and guides the user through pH, EC and plant height sensors calibration. In step 1308, the main plant water tank 803 is automatically filled and the device fans are automatically turned on. In step 1310, the user is guided to set his desired “light on” hours meaning in what hours the devise cabinet will be lighted by the lighting means of the device 800. In this step the user is also guided to set his own desired hours in which the user will be able to open the door to maintain his plant. In this step the device 800 let the user choose the time that is best for his personal schedule.

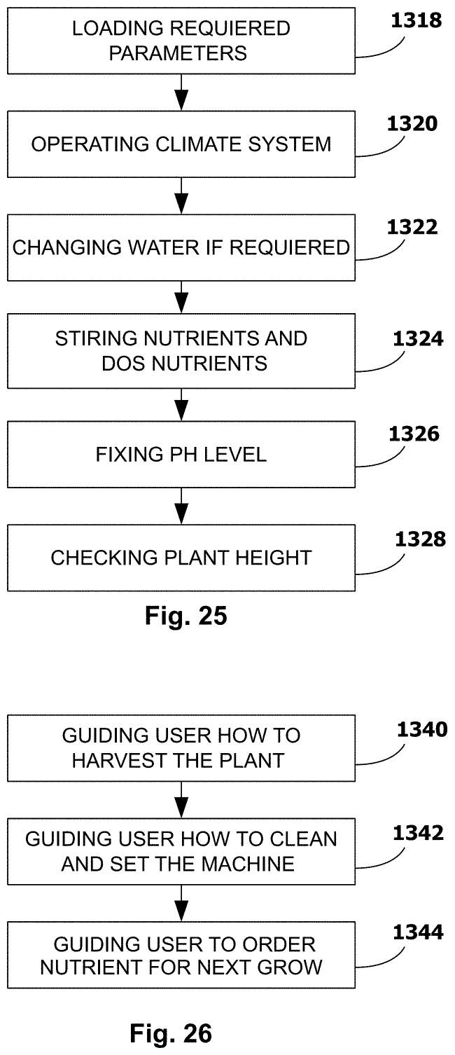

Referring to FIG. 25, the grow recipe executer mode includes the following actions, all of which are executed by the device 800 automatically, in step 1318 loading the required parameters for each day of the grow from the grow recipe. In step 1320, Operating the climate sub-system to meet the required temperature and relative humidity (RH). Relative humidity (RH) refers to the amount of water in the air relative to the maximum amount of water that the air can hold at a given temperature, The relative humidity (RH) is the ratio of the actual water vapor pressure to the saturation water vapor pressure at the prevailing temperature. In step 1322, changing water if required in specific day. In step 1324, stirring nutrients and dose nutrients if required. In step 1326, fixing the pH level if needed. In step 1328, checking plant height with a height sensor.

Referring to FIG. 26, the post grow mode includes in step 1340, sending notification to the user and guiding the user how to harvest the plant. In step 1342, sending notification to the user and guiding the user how to clean and set the machine for drying or for next grow. In step 1344, sending notification to the user and guiding the user to order nutrients and other grow materials for his next desired next plant grow.

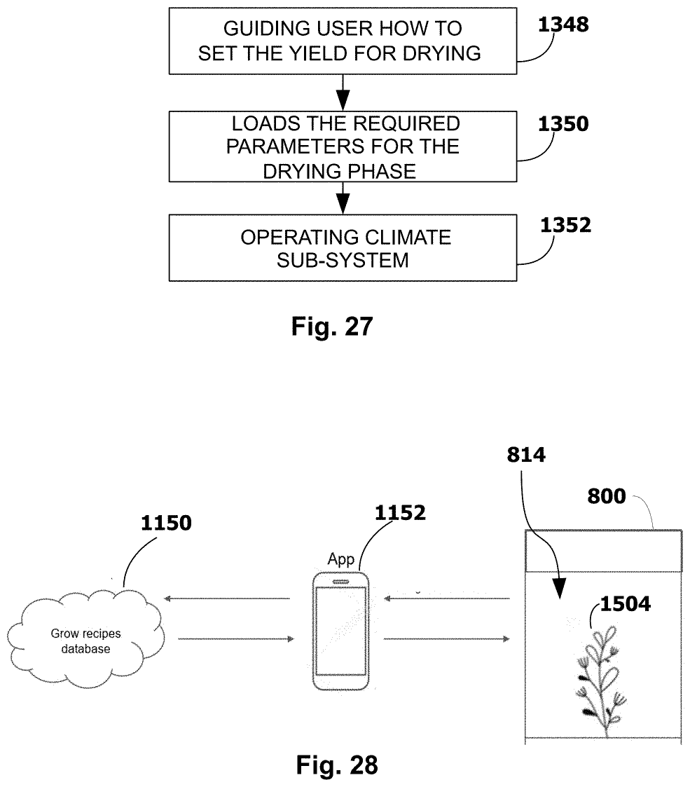

Referring to FIG. 27, the drying mode includes, in step 1348, notifying the user and guiding the user how to set the yield for drying inside the machine. The device loads the required parameters for each day of the drying phase from the grow recipe in step 1350. Operating climate sub-system to meet the required temperature and relative humidity (RH) in step 1352.

Referring to FIG. 2, FIG. 28 each plant and strain genetic structure determines the potential of the plant's yield. In order to achieve this potential, it is important that the growing conditions during the plant growth will be adjusted accordingly. Because of the huge diversity of plants and strains that may require different conditions for each of them to achieve optimal growth, it is difficult for home growers to determine what are the most suitable parameters for the plant they are growing. The desired parameters by which the controller 889 operates the components in the device 800 such as but not limited to air temperature and humidity, water temperature and fertilizers quantities are determined by the grow recipe.

The grow recipe contains all the data required for growing the plant in optimal conditions and includes a set of desired values which may be different on each day of the growing cycle. The grow recipe is different for every plant and each strain and the user may choose the one that fits the plant he wants to grow out of a list of growing recipes which will be available using the mobile application of said user's mobile device 1152. If the user wants to determine some of the parameters manually, he is able to create a custom grow recipe by changing some of the parameters in an existing recipe and saving it. In case a user is interested in sharing a grow recipe which has yielded him good results, he may upload the new grow recipe which he created to a grow recipe database on the server 1150 and enable other users to use this recipe. In order to share his results of using the custom recipe the user is able to do at least one of the following:

1. Upload pictures and time lapse of the plant during the growing cycle which will present the process and will allow other users to be impressed by the recipe

2. Share his experience and impression of the yield's quality such as but not limited to taste, smell and quantity of the yield.

3. For medicinal plants, the user is able to conduct a lab analysis test which he will perform and that will reflect on the ingredients concentration in the plant such as but not limited to THC and CBD.

As opposed to industrial and large-scale growing devices, where the knowledge for optimal growing conditions is achieved by a single person or company, the grow recipe database and custom features will allow users to create a common knowledge database for home growers, in an easy to use and accessible manner.

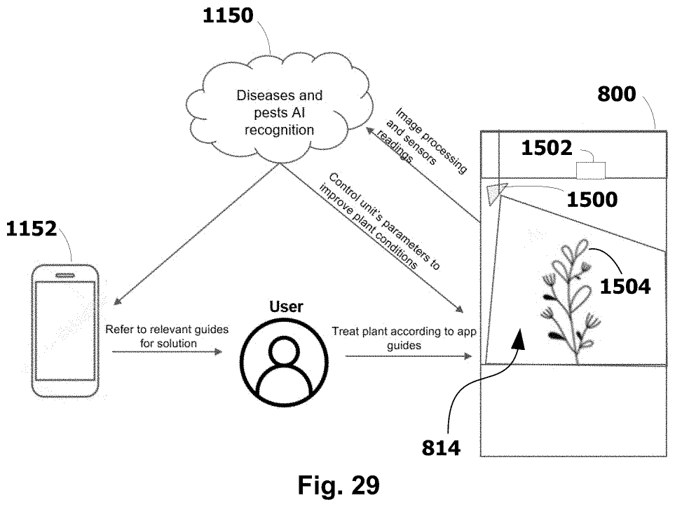

Referring to FIG. 29, during a plant's growth there are various issues that may occur which might be dangerous to the plant such as but not limited to diseases and pests. The device 800 uses inputs received from different sensors including but not limited to a camera 1500 and plant height sensor 1502 in order to detect these problems and determine what are the required actions for solving them. The data collected from the sensors is sent to server 1150 where it is analyzed using image processing and Artificial Intelligent (AI) algorithms in order to determine whether plant's growth 1504 is progressing as expected. Based on the results of the analysis the device 800 will do at least one of the following: 1. Change the required parameters in the grow recipe such as air temperature and humidity, fertilizers quantities, water temperature, water acidity in order to solve the issue by providing the plant with the proper conditions. 2. The server 1150 will send instruction data to the user's mobile device 1152 that will instruct the user by presenting him with videos and guides for actions that require his intervention. These actions might be cleaning the growing chamber, trimming the plant, or referring the user to purchase and use products associated with plant health. Detecting and solving problems during the grow might be critical for ensuring the plant's health and these measures will ensure that the required actions will happen before the damage done to the plant is irreversible.

It should be understood that the above description is merely exemplary and that there are various embodiments of the present invention that may be devised, mutatis mutandis, and that the features described in the above-described embodiments, and those not described herein, may be used separately or in any suitable combination; and the invention can be devised in accordance with embodiments not necessarily described above.

What is claimed is:

1. A plant growing device for personal home use in an insulated environment comprising:
a cabinet having a cabinet door and having a plurality of compartments for accommodating different facilities of said plant growing device and a space for plant growth;
at least one water tank having water-based solution inside said water tank for said plant growth;
at least one controller;
a lighting means electrically connected to said controller, said lighting means is used for lighting at least one of said compartments according to said controller instructions;
a watering subsystem electrically connected to said controller;
environmental sensors to provide input data about the environmental conditions in said plurality of compartments and in the room where said device is placed, where at least one of said compartment is a plant growing space;
plant sensors electrically connected to said controller to provide input data about the plant physical parameters;
water level sensors where at least one of said sensors is electrically connecting to said controller to provide input data about the watering level in said at least one water tanks;
a dosing subsystem controlled by said controller which is used for selectively dispensing/delivering the required amounts of each of a plurality of nutrients into the water-based solution inside the water tank automatically according to the instructions of said controller;
a climate subsystem having an air cooler, air humidifier and air heater; said climate subsystem controlled by said controller;
a watering subsystem controlled by said controller;
a communication module to communicates with at least one database server and at least one mobile device;
wherein, said plant growing device receives constant flow of renewed air from the air surrounding said cabinet though cabinet air inlet; said received flow of air is flowing in a predefined path in various components of said climate subsystem, and thereby, the air flow parameters are changed for preventing climate parameters volatility of predefined climate parameters in said cabinet in particular when air cooler is activated, for optimal growth of said plant; when said air reaches the end of said air path, the air flows outside of said plant growing device from a cabinet air outlet to the surrounding of said plant growing device.

2. A plant growing device according to claim 1, wherein said climate parameters selected form a group of CO₂ concentration in the air, air humidity and air temperature.

3. A plant growing device according to claim 1, wherein:
said device further comprises a water-cooling subsystem for cooling said plant water tank; said water cooling subsystem having an immersed pump, heat-exchanger and at least two water tubes;
wherein when the temperature of the water in said plant water tank is above the desired temperature level, said immersed pump flows water from said plant water tank through the heat exchanger from one water tube and back to the water tank through the second water tube in order to maintain the desired water temperature in said water tank.

4. A plant growing device according to claim 3, wherein:
said heat exchanger is connected by an AC tube to an evaporator of an air conditional (AC) which is part of said climate subsystem;
wherein the cold refrigerant gas that runs through said tube of said AC runs around said first water tube in the opposite direction to the water that flows from said immersed pump;
said first water tube is connected in one end to said immersed pump and the other end of said first water tube is connected to an inlet of said heat exchanger; and
said second water tube is connected in one end to an outlet of said heat exchanger; the other end of said second water tube is connected to said plant water tank and is used for returning the cooled water back to said plant water tank.

5. A plant growing device according to claim 1, wherein:
said device further comprises an excess water reduction subsystem for collecting drops of waters and accelerating the process of water evaporation of excess water in particular when the air conditioner of said climate subsystem is activated for cooling the plant growth compartment.

6. A plant growing device according to claim 5, wherein:
said excess water reduction subsystem comprises a water storage tank for collecting the drops of water that drops from said air conditioner and water heating element located inside said water storage tank wherein, when said heating element is activated said water inside said water storage tank is evaporated and evacuated out of said plant growing device and thus help said plant growing device to dispose of said excess water.

7. A plant growing device according to claim 6, wherein:
said excess water reduction subsystem further comprises an immersed pump, plurality of water level sensors and means for dropping drops of water on condenser hot ribs of said air conditioner of said climate subsystem;
a second immersed pump;
when said water storage tank exceed a maximum predetermined level, said second immersed pump is activated for passing water outside of said plant growing device; and
wherein, if the water level inside the water tank exceeds a predetermined level , said immersed pump is activated to transfer water from said water tank through a tube to said means for dropping drops of water on the condenser hot ribs of said air conditioner to be evaporated and evacuated out of the plant growing device.

8. A plant growing device according to claim 7, wherein:
said means for dropping drops of water on the condenser ribs of said air conditioner has a tray with holes for dropping drops of water on the hot condenser ribs of said air conditioner.

9. A plant growing device according to claim 1, wherein:
said various components that said air flow go through in a predefined path comprising said cabinet air inlet, a fleece filter, a first air tunnel, said evaporator, a second air tunnel, at least one heater, said humidifier, a grow chamber air inlet fan, circulation fans, a carbon filter, an outlet suction blower, a lighting means heat sink and an air outlet fans;
wherein flow of air from the atmosphere surrounding said cabinet enters the cabinet air inlet the air flows inside said first air tunnel through a fleece filter and passes to said evaporator for cooling the air if needed and said heating means for heating the air in said cabinet if needed for optimal growth of the plant;
water vapors generated by said humidifier are added into said air through a humidifier outlet of a vapor tube for humidifying the air if needed for optimal growth of said plant; said air is then pushed into said plant growth space by said air inlet fan;
said circulation fans circulate the air inside said plant growth space in order to create homogeneous conditions in the growing chamber with the desired air temperature, CO₂ concentration and humidity for optimal growth of said plant;
said outlet suction blower pushes the air out of the growing chamber through said carbon filter and towards the lighting means heat sink in order to cool and evacuate heat more efficiently; and
finally, air outlet fans push the air back outside of said cabinet.

10. A plant growing device according to claim 1, wherein:
said dosing subsystem comprises a platform having a plurality of detachable and replaceable cartridges arranged in a spaced-apart relationship, and each being configured to be connected to a respective dosing pump;
each of said dosing pump having respective pump tubes; each of said cartridges carries a specific nutrient or mixture of nutrients, at least one cartridge carry a pH stabilizer, such that the dosing system is capable of delivering one or more nutrients simultaneously or sequentially in exact timing and dosage as will be automatically instructed by said controller to said water-based solution inside said water tank; and
said dosing system further comprises an electrical conductivity (EC) sensor connected to said controller to monitor and measure the electrical conductivity in said water-based solution in said water tank.

11. A plant growing device according to claim 10, wherein:
said dosing subsystem further comprises stirring motors for each of said cartridges and a stirring unit assembly;
said dosing cartridge comprises a container a cover, a cap, a check valve with nozzle, and stirring element means;
wherein in order to prevent sediments of the fertilizers contained in said cartridges each of said cartridge has a stirring element means; the bottom portion of said stirring unit assembly is connected to a motor shaft of said stirring motors which are controlled by said controller.

12. A plant growing device according to claim 11, wherein:
said stirring unit assembly comprises at least two stirring magnets, a rotating magnets arm and a rotating arm support;
said rotating magnets arm have holes fitted such that the stirring magnets can be inserted by pressure in said holes;
said rotating magnets arm is attached to said arm support;
said stirring unit assembly further comprising a motor shaft attachment means to attach said rotating magnets arm to said stirring motors shafts;
when at least one of said stirring motors is instructed by the controller to operate said stirring motor, said stirring motor shafts are rotated and thus the respective magnet arm is rotated around the stirring motor shaft;
stirring magnets are then also rotated which causes the magnet stirring element inside said cartridge to spin;
thereby the spin of said stirring element inside said cartridge mixes the fertilizers in said cartridge and thus mixing said nutrient or nutrient mixture or PH stabilizer and preventing sediments of the fertilizers in the bottom surface of said cartridge from reaching said water tank unmixed.

13. A plant growing device according to claim 11, wherein:
said dosing subsystem further comprising a nozzle for dispensing the fertilizers content that are inside said cartridges to said plant water tank; and
said dosing system further comprising valves, that allows one direction flow of the fertilizers from said cartridge to said water-based solution water tank when said respective cartridge pump is operated.

14. A plant growing device according to claim 10, wherein:
said cartridge further comprises a sediments filter for preventing said nozzle from being clogged by fertilizer's sediments.

15. A plant growing device according to claim 14, wherein:
said sediments filter is a protruded hollow element attached perpendicular to said nozzle having a notch from which said fertilizer content inside said cartridge can pass through to said nozzle; and
said sediments filter extends upwards from the cartridge base corner and said notch is not pointing to the stirring direction;
thereby, said sediments filter prevents said sediments if exist in said cartridge from clogging said notch.

16. A plant growing device according to claim 13, wherein:
said dosing subsystem further comprises a mechanical coding means for ensuring that every cartridge is placed in the right order and place in said platform.

17. A plant growing device according to claim 1, wherein:
said humidifier also having a heater and a humidifier tank that can be automatically filled when needed;
wherein when said humidifier is activated said heater is also be activated, the activation of said heater allows the air to absorb a higher amount of water vapor in warm air than in cold air and thus relatively increasing more rapidly the humidity in the fresh or conditioned air that will be flown to said plant growing space.

18. A plant growing device according to claim 1, wherein:
said humidifier is automatically controllable by said controller in a way that allows to change the amount of water vapor added to the air inside said cabinet; and
said humidity sensor constantly measures the relative humidity inside said plant growing space and the relative humidity in the incoming air from outside of the plant growing device and respectively adjusts the duty cycle for aid humidifier, allowing said plant device to constantly maintain the required relative humidity in said plant growing space.

19. A plant growing device according to claim 1, wherein:
said device collects sensor data received from said plant sensors; said data collected from the sensors is sent to a server where it is analyzed using image processing and Artificial Intelligent (AI) algorithms in order to determine whether plant's growth is progressing as expected;
based on the results of the analysis said device will do at least one of the following: one, change the required parameters in the grow recipe such as air temperature and humidity, fertilizers quantities, water temperature, water acidity in order to solve the issue by providing the plant with the proper conditions, and second, said server will send instructional data to the user's mobile device that will instruct the user by presenting him with videos and guides for actions that require his intervention.

20. A plant growing device according to claim 1, wherein:
said database server further has a grow recipe database which will allow users to create a common knowledge database for home growers, in an easy to use and accessible manner.
